(19) United States
(12) Patent Application Publication
(10) Pub. No.: US 2007/0107491 A1
(43) Pub. Date: May 17, 2007

(54) Measuring device for the measurement of dewatering rates of paper machines

(76) Inventors: Jennifer Petersen, Heidenheim (DE); Timo Ramsayer, Konigsbronn (DE); Andreas Schafer, Heidenheim (DE); Christoph Strempfl, Herbrechtingen (DE)

Correspondence Address: TAYLOR & AUST, P.C., 142 SOUTH MAIN STREET, P. O. BOX 560, AVILLA, IN, 46710, US

(21) Appl. No.: 11/544,134

(22) Filed: Oct. 7, 2006

(30) Foreign Application Priority Data
Oct. 7, 2005 (DE) DE102005048 053.5

(51) Int. Cl. G01F 25/00

(52) U.S. Cl. 73/1.16

(57) ABSTRACT

The invention relates to a measuring device for measurement of the volumetric flow of liquids, in particular for the measurement of dewatering rates from paper machines, having a container for receiving a liquid whose volumetric flow is to be measured, whereby the container has a bottom on which the liquid collects, and having an inlet for the liquid and an outlet for the liquid, whereby inserted in the outlet is a measuring aperture which has an opening for the outflow of liquid from the container. The measuring aperture opening extends upward in a vertical direction in the container, starting at an overflow level at a defined distance above the container bottom. Also, the measuring device has a pressure sensor which is arranged in or on the container, at least partly below the measuring aperture opening, in order to measure the static pressure in a liquid column collecting in the container as the result of the inflowing liquid. The measuring device of the invention including a lower region of the measuring aperture opening that can be closed in order to raise the overflow level by a defined extent for checking the calibration of the measuring device.

### BACKGROUND OF THE INVENTION

1. Field of the Invention

The present invention relates in general to a measuring device for the volumetric flow measurement of liquids and to a method for checking the calibration of such a device. In particular the present invention relates to a measuring device for the measurement of dewatering rates from paper machines, such measuring devices also being referred to as measuring boxes.

2. Description of the Related Art

During the production of paper it is necessary to dewater the paper web at various points of the paper machine, for example in the region of the mesh section, the press section or the drying section. For the paper producer it is important to know the rates of dewatering, meaning the volumetric flow of the removed liquid.

To date such dewatering rates have been measured by way of so-called measuring boxes, which steady the liquid flow up to a type of weir, direct it over the weir to a pressure sensor seated underneath the measuring box, and then discharge the liquid again, without any intermediate storage thereof. The liquid is discharged by way of an aperture arranged at the front of the measuring box. Measuring sensors used are both non-contacting and contacting measuring sensors, for example gearwheels which are rotated by the liquid flow, whereby the rotation is detected by a magnetoresistive sensor, amplified and output as a pulse.

It can be considered a drawback of the measuring boxes used hitherto that they are hard to clean, require trained personnel from the electrical engineering field to check the calibration, and have a rigid measuring range on account of their rather inflexible construction.

What is needed in the art is a measuring device that is easy to clean, easy to calibrate and has a flexible measurement range.

### SUMMARY OF THE INVENTION

An object of the present invention is to disclose an improved measuring device for the volumetric flow measurement of liquids and a method for checking the calibration of such a measuring device. In particular, the measuring device enables an easy calibration check, such that a check can also be carried without the help of trained electrical engineering personnel. Further, the present invention is characterized by a flexible construction that can be easily adapted to the specific point of use or to the liquid rate in question.

The present invention is constructed for the measurement of dewatering rates from paper machines or is a part of a paper machine. The present invention including a container for receiving the liquid whose volumetric flow is to be measured. The container has a container bottom, whereby the liquid is collected in the container in such a way that it forms a liquid column standing on the container bottom.

Accordingly, the container has an inlet for the liquid, the inlet being arranged in particular in the upper region of the container and possibly including a down-pipe, meaning a pipe arranged vertically or essentially vertically by which the liquid is introduced into the interior space of the container. In this case the down-pipe can pass through a lid of the container. The lid is equipped, advantageously, with at least one opening, and can end in the immediate vicinity of and a defined distance away from the container bottom, for example in the bottom quarter of the container, or can open into the interior space of the container.

The container has an outlet for the liquid, into which a measuring aperture is inserted. The measuring aperture has an opening through which the liquid escapes from the container. The measuring aperture opening extends in a vertical direction in the container, having a shape such as a rectangle, in particular an upright rectangle, meaning a rectangle that is higher than it is wide. In this connection it should be noted that the measuring aperture opening can also have other shapes. Hence the measuring aperture or the measuring aperture opening forms an overflow beginning at a defined overflow level. If liquid is continuously introduced into the container it will begin at the level of the overflow, which is positioned at a defined distance above the container bottom, to flow through the measuring aperture opening and out of the container. On the other side of the measuring aperture, meaning outside the container or on the outside thereof, provision is made advantageously for a collecting container or, more generally, a collecting device in order to collect and/or divert the overflowing liquid.

As long as liquid is introduced into the container when the container is empty or only partly filled, meaning the water column does not yet extend up to the measuring aperture opening, then the following happens: The liquid, which is introduced by the above described down-pipe into the container, passes to the bottom part of the container where the liquid has a chance to steady itself because of the far bigger cross section of the container in which the liquid rises. This causes the flow velocity to be reduced on account of the bigger cross section. The liquid collects over the entire cross section of the container and, with a continuing inflow of liquid, rises in the container in the form of a liquid column until the level of liquid reaches the overflow level, meaning the lower edge of the measuring aperture opening. As the inflow of liquid continues, the liquid now begins to flow by way of the measuring aperture opening and out of the container. The liquid level rises further until the volumetric flow of liquid flowing out of the measuring aperture opening corresponds to the volumetric flow of liquid flowing in the down-pipe or, more generally, the inlet. When an equilibrium exists between the inflowing volumetric flow of liquid and the outflowing volumetric flow of liquid, the liquid level, in the region of the measuring aperture opening, remains stationary, advantageously at a defined distance below its upper end.

The measuring device of the invention has a pressure sensor, which is arranged in or on the container at least partly below the measuring aperture opening, advantageously completely below the lower end of the measuring aperture opening. The pressure sensor measures the static pressure of the liquid column which has collected in the container and presses against the pressure sensor, for example a membrane. When, as previously described, the liquid level adopts a constant level, a constant pressure is detected by the sensor and can be used to calculate the volumetric flow of the liquid flowing into the measuring device.

The measuring device of the present invention measures the static pressure of the liquid column, which arises as a function of the column height, the latter being defined by the relationship between inflowing and outflowing liquid volumes. As soon as a stationary condition of the liquid column height, meaning the liquid level, is reached, albeit only briefly, with the exception of pressure fluctuations, particularly in the inlet, it is possible to calculate, simply from the static pressure of the liquid column and the known cross section of the effective measuring aperture opening, the inflowing liquid volume and simultaneously outflowing liquid volume per unit of time.

To check the calibration of the measuring device the lower region of the measuring aperture opening can be closed in order to simulate a predefined maximum overflow level, which lies above the overflow level of the bottom edge of the measuring aperture opening. By closing the lower region of the measuring aperture opening it is thus possible to exactly define an overflow level above the bottom edge of the measuring aperture opening without any influence from fluctuations of the volumetric flow in the inflow of liquid into or outflow of liquid out of the container.

Now, the container can be filled with liquid until the overflow edge on the defined maximum overflow level is reached or just exceeded, meaning up to the point when the liquid begins to flow via the measuring aperture opening and out of the container. The static pressure of the related liquid column can be measured by way of the pressure sensor and thus be used to check the calibration of the measuring device.

After the calibration has been checked, the measuring aperture opening is fully opened again for the measuring mode of the measuring device. This is done, for example, by removing a baffle plate previously covering the measuring aperture opening in the lower region. The baffle plate is arranged, for example, inside the measuring aperture opening such that it can be slid from top to bottom, or elsewhere such that it can be moved into and out of the lower region of the measuring aperture opening, with the result that the measuring aperture opening is either completely unobstructed or its lower region is closed by the baffle plate.

According to another aspect of the present invention, the inlet of the measuring device includes a down-pipe, which extends essentially vertically in the container and has a lower opening arranged below the measuring aperture opening, from which the liquid can be directed into the container. When the liquid flows into the container, the lower opening of the down-pipe is immersed as the water column builds up in the container. A surge shaft is thus formed in the container. The function of such a surge shaft is to cushion pressure fluctuations in the inlet. This construction enables, in particular, the measurement of volumetric flows of liquid from lines under vacuum. Making provision for a free liquid level, which can rise and fall in the container of the measuring device and delimits a water column in which the down-pipe is immersed, resulting in a vacuum-tight sealing of the down-pipe and the inlet. At the same time, pressure fluctuations in the inlet are cushioned by the rise and fall of the water level in the container.

The measuring device of the present invention is advantageously adapted to accommodate various measuring sensors interchangeably. Also, the measuring aperture is advantageously interchangeably fixed, in particular in an upper region of the container. Hence the measuring device can be very flexibly equipped with various measuring sensors and/or apertures for different flow rates.

Unlike the state of the art, the calibration of the inventive measuring device can be checked without removing the pressure sensor or pressure transmitter and without the assistance of an electrician. In particular, by fitting a baffle plate over the measuring aperture it is possible, during a machine stoppage, to close the measuring aperture opening, fill the container up to a predefined value, measure the related pressure and advantageously check with a provided digital indicator, for example, which value is indicated and which value should be indicated according to theory. If there are any deviations, arrangements are easily made for the necessary calibration.

A suitable measuring aperture for the respective liquid quantity, in particular water quantity, can be used from a multiplicity of measuring apertures provided.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic cross section of a side view of an embodiment of a measuring device constructed according to the present invention; and

FIG. 2 is another side view according to FIG. 1 offset by an angle of 90 degrees, as seen from the right in FIG. 1.

Corresponding reference characters indicate corresponding parts throughout the several views. The exemplification set out herein illustrates embodiment of the invention, in one form, and such exemplification is not to be construed as limiting the scope of the invention in any manner.

### DETAILED DESCRIPTION OF THE INVENTION

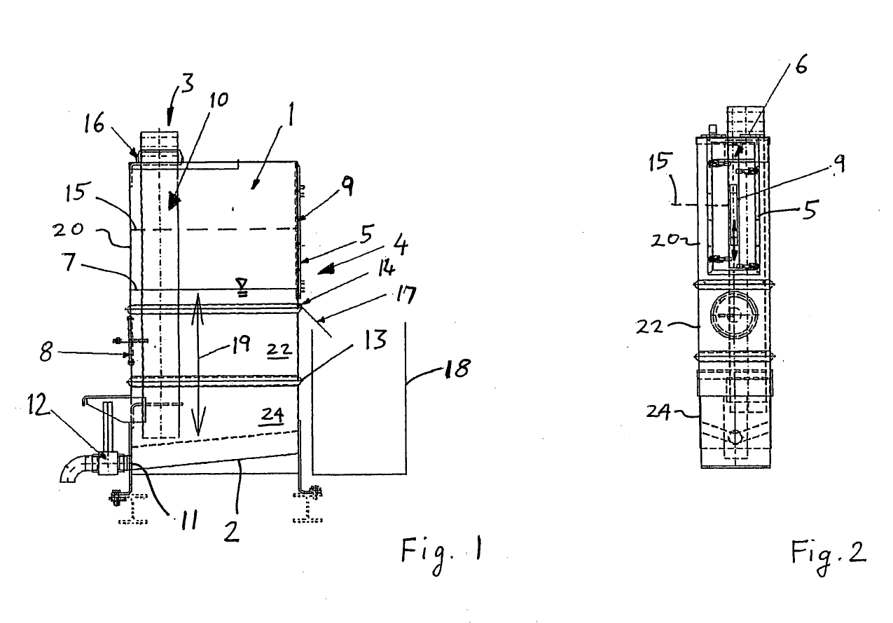

Referring now to the drawings, and more particularly to FIGS. 1 and 2, The measuring device includes a container 1 with a container bottom 2. Container bottom 2 is arranged at an angle such that it has a gradient which directs the liquid in container 1 to a side wall. At the lower end of which provision is made for an additional outlet opening 11 into which a ball valve 12 leads. Hence it is possible to fully empty container 1 by opening ball valve 12.

Immersed in container 1 is a down-pipe 10 which, as can be seen, ends directly above container bottom 2. Down-pipe 10 has an inlet 3 through which the liquid, in particular water, whose volumetric flow is to be measured, is fed into container 1.

In the normal operating state of a measurement, ball valve 12 is closed, as the result of which the water flowing into container 1 collects on container bottom 2 and forms a water column that rises in container 1. Pressure fluctuations in the inlet 3 can be compensated for by a corresponding adjustment of the height of the water column in container 1, see the double arrow 19, without running a risk of air getting into the lower end of down-pipe 10 from outside; hence a vacuum-tight sealing of inlet 3 is assured, thus enabling the measurement of even volumetric flows of liquid from lines under vacuum.

Given a continuous volumetric flow through inlet 3 in container 1, the liquid level rises until the inflowing volumetric flow enters into an equilibrium with an outflowing volumetric flow. In this case the outflowing volumetric flow exits by way of a measuring aperture opening 6 of measuring aperture 5 provided on the side of the container wall, which, as is evident from FIG. 2, has a rectangular cross section. As the water level in container 1 rises, so the outflow cross section of the outflowing liquid flow grows in a linearly proportional manner until the state is reached in which the outflowing volumetric flow corresponds to the inflowing volumetric flow.

With the exception of the additional outlet 11, whose function will be explained later, outlet 4, by way of measuring aperture opening 6, is the sole outlet in container 1. The water from outlet 4 flows into a collecting container 18, as is implied by ramp 17.

The bottom edge of measuring aperture opening 6 defines an overflow level 7, meaning the level or height of the liquid surface inside container 1 starting at which the liquid begins to flow out by way of outlet 4 and measuring aperture opening 6.

At the moment at which the liquid level in container 1 adopts a stationary or essentially stationary position, advantageously without allowance for pressure fluctuations in inlet 3, the volumetric flow of the liquid flowing into container 1 can be calculated from the static pressure in the water column. The static pressure is measured by pressure sensor 8 provided below measuring aperture 5 located in the opposite side wall of container 1. As the height of the liquid column in container 1 rises, meaning as the head height increases, so the static pressure detected by pressure sensor 8 rises such that the head pressure is proportional to the volumetric flow of the liquid through the measuring device.

To check the calibration of the measuring device, provision is made for a baffle plate 9, which can be inserted into the lower region of measuring aperture opening 6 in order to close, liquid-tight, this region starting from the bottom edge of measuring aperture opening 6. In one embodiment of the present invention, baffle plate 9 can be fastened to and detached from container 1 using so-called quick-release locks. Alternatively, baffle plate 9 can be constructed in the form of a slide which can be slid from an inactive position, in which measuring aperture opening 6 is completely unobstructed, i.e. in which an outflow of liquid through the measuring aperture opening 6 is not hindered, into a lower position (active position), whereby in the latter position it raises the minimum overflow level 7 of the measuring device, which is defined by the bottom edge of the measuring aperture opening 6, to a higher lying overflow level 15, which is defined by the top edge of the fully lowered slide. Hence container 1 can be filled with liquid up to overflow level 15 and the related pressure value determined by way of pressure sensor 8, for example by reading from a provided indicator (not illustrated).

After the calibration has been checked, baffle plate 9 is removed again from container 1, leaving the measuring aperture opening 6 completely unobstructed.

Container 1 can have an interior space open to the surroundings. In the embodiment illustrated, container 1 has a lid which can be opened by way of a handle for cleaning.

Ball valve 12 is used for cleaning the measuring device and container 1. Using another inlet (not illustrated), which can include a rinsing line of pressure sensor 8 or a supply line in container 1. For example, container 1 can be filled with water, in particular in a period without measured value acquisition, and ball valve 12 is opened simultaneously or subsequently so that the water can flow via it and out of the container 1. This results in the cleaning of the interior space of container 1 and, at the same time, pressure sensor 8.

Arranged in a lower section 24 of the side wall are additional outlet 11 with ball valve 12 and, of course, inclined container bottom 2. Positioned in a middle section 22 of the side wall is pressure sensor 8. Arranged in an upper section 20 of the side wall is measuring aperture 5 and, fixed to the lid on upper section 20 of the side wall, is down-pipe 10, which extends beyond middle section 22 into the lower section of the side wall.

If container 1 is constructed in several parts, then it is possible, thanks to this modular configuration, to form a single container by combining different side wall sections for specific purposes, in particular dependent on the expected liquid rate. For example, a series of middle side wall sections 22 with different measuring sensors or pressure sensors 8 can be held ready. Similarly, a multiplicity of upper sections 20 with different down-pipes 10 and/or measuring apertures 5, differing in particular in the size and shape of the measuring aperture opening 6, can be held ready. Also, the vertical dimensions of the respective side wall sections can vary, thus enabling a suitable container with an optimum pressure sensor 8, the optimum measuring aperture 5 and the optimum height of the complete container or individual sections to be assembled quickly and cost-effectively for the purpose in question, without it being necessary to install pressure sensors and/or measuring apertures in the side walls, which can entail a complicated sealing operation.

Container 1 includes an upper section 20, a middle section 22 and a lower section 24. Sections 20 and 22 are connected by way of band connector 14. Sections 22 and 24 are connected by way of a band connector 13. Sections 20, 22 and 24 are detachably connected and can be interchanged with different shapes and can have different pressure sensors and measuring apertures. Additionally, sections 20, 22 and 24 may have different heights, which allows considerable versatility of heights. All of which allows considerable versatility to alter the measuring capabilities of the present invention.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A measuring device for the measurement of a volumetric flow of a liquid to determine dewatering rates of a paper machine, comprising:
a container for receiving the liquid whose volumetric flow is to be measured, said container including:
a bottom on which the liquid collects;
an inlet for the liquid; and
an outlet for the liquid;
a measuring aperture being inserted in said outlet, said measuring aperture having an opening for the outflow of the liquid from said container, said measuring aperture opening extending upward in a vertical direction starting at an overflow level that is defined as a predetermined distance above said container bottom, said measuring aperture opening having a lower region; and
a pressure sensor arranged at least partly below said measuring aperture opening in order to measure the static pressure in a liquid column collecting in said container as the result of the inflowing liquid, said lower region of said measuring aperture opening being closeable in order to raise said overflow level by a defined extent for checking calibration characteristics of the measuring device.

2. The measuring device of claim 1, further comprising one of a detachable baffle plate and a movable baffle plate placed in a region of said measuring aperture by way of which said lower region of said measuring aperture opening is closeable.

3. The measuring device of claim 2, wherein said inlet includes a down-pipe arranged approximately vertically in said container, said down-pipe having an outlet opening below at least one of said pressure sensor and said measuring aperture opening, said outlet opening being directly above said container bottom.

4. The measuring device of claim 3, further comprising:
an additional outlet opening located in a lower end of said container in particular in one of a side wall of said container and said bottom of said container; and
one of a ball valve and a slide valve connected to said additional outlet, which can close said additional outlet opening.

5. The measuring device of claim 4, wherein said container bottom has a gradient with a lowest point of which is proximate to said additional outlet opening.

6. The measuring device of claim 5, wherein said measuring aperture opening has a rectangular cross section.

7. The measuring device of claim 6, wherein said rectangular cross section is in the shape of an upright rectangle.

8. The measuring device of claim 6, wherein said measuring aperture is interchangeably fixed in an upper section of said container.

9. The measuring device of claim 8, wherein said side wall of said container encloses an interior space of said container having a lower section, a middle section and an upper section, said pressure sensor being arranged in said middle section, said measuring aperture being arranged in said upper section.

10. The measuring device of claim 9, wherein said down-pipe leads into said lower section.

11. The measuring device of claim 10, wherein said lower section and said middle section are detachably connected together, said middle section and said upper section being detachably connected together with differently shaped sections being interchangeable therewith, said sections having at least one of a different pressure sensor, a different measuring aperture and a different vertical dimension.

12. A method for checking the calibration of a measuring device for the measurement of a volumetric flow of a liquid to determine dewatering rate of a paper machine, comprising the steps of:
closing a measuring aperture opening up to a defined maximum overflow height of a measuring aperture, said measuring aperture connected to a container;
forming a liquid column in said container with one of a liquid whose volumetric flow is to be measured and a substitute liquid with the same physical properties as said liquid whose volumetric flow is to be determined, said liquid of said liquid column being introduced by way of an inlet into said container such that said liquid column forms on a bottom of said container and grows upward until it reaches said maximum overflow height at which point said liquid flows by way of said measuring aperture opening out of said container;
using a pressure sensor to measure a static pressure of said liquid column and calibrate the measuring device at a maximum value; and
fully opening said measuring aperture opening for operation of the measuring device.
